(19) United States
(12) Patent Application Publication
(10) Pub. No.: US 2025/0243902 A1
(43) Pub. Date: Jul. 31, 2025

(54) AERODYNAMIC BEARING AS WELL AS A BEARING ARRANGEMENT COMPRISING TWO AERODYNAMIC BEARINGS FORMED AS RADIAL BEARINGS

(71) Applicant: ebm-papst Mulfingen GmbH & Co. KG, Mulfingen (DE)

(72) Inventor: Mihai B. DOBRICA, Heidelberg (DE)

(21) Appl. No.: 19/042,111

(22) Filed: Jan. 31, 2025

(30) Foreign Application Priority Data
Jan. 31, 2024 (DE) 102024102698.7

(51) Int. Cl. F16C 32/06

(52) U.S. Cl. CPC F16C 32/0607; F16C 2360/24

(57) ABSTRACT

An aerodynamic bearing for axial and/or radial mounting of a shaft for a turbocompressor, wherein the aerodynamic bearing has a first bearing part denotable as a rotor, and a second bearing part denotable as a stator. The first bearing part and/or the second bearing part have a bearing surface facing the respective other bearing part and on which a gas cushion for aerodynamic mounting is generatable between the bearing parts. The bearing surface has a plurality of depressions, each following a predetermined longitudinal profile on the bearing surface and arranged to form a predetermined pattern. The longitudinal profile has two sections which merge into one another at an apex located on an apex line which is displaced in parallel with respect to a center line of the bearing surface, so that the longitudinal profile is asymmetrical with respect to the center line.

### RELATED APPLICATIONS

This application claims priority to German Patent Application No. 10 2024 102 698.7, filed Jan. 31, 2024, the entire contents of which is incorporated herein by reference in its entirety.

### FIELD

The disclosure relates to an aerodynamic bearing for axial and/or radial mounting of a shaft for a turbocompressor, in particular a high-speed turbocompressor, extending along an axis of rotation, as well as to a bearing arrangement with two aerodynamic bearings formed as radial bearings.

### BACKGROUND

Aerodynamic bearings, which may also be referred to as gas or air bearings, respectively, have been known in the prior art for a long time. In this regard, a gas or air cushion, respectively, is built up as a lubricant between two bearing partners or bearing surfaces provided by them, respectively, so that the bearing partners or bearing parts, respectively, can rotate relative to one another essentially without any contact or friction.

In order to increase the stability or the maximum possible rotational speeds with the bearing, respectively, it has also been known for a long time to introduce depressions into the bearing surfaces, by means of which the gas or air cushion, respectively, remains consistent and loadable, in particular at high rotational speeds, so that even at high rotational speeds or high loading of the bearing, a pressure distribution required for mounting is maintained on the bearing surfaces.

In thrust bearings, the depressions can be formed, for example, in a spiral-like fashion, and in radial bearings, for example, in an arrow-like fashion, and can each be arranged to form a herringbone pattern, so that mutually adjacent depressions engage one another in a non-contacting manner.

In this case, it is provided in the prior art that the depressions, in particular in the case of an arrangement in the herringbone pattern, are arranged symmetrically with respect to a center line dividing the respective bearing surface of the bearing part, so that the apexes of depressions in an arrow shape are thus located on the center line.

Correspondingly, the main bearing point or main support region, respectively, determined by the pressure distribution on the bearing surface is located on the center line.

If multiple such aerodynamic bearings formed as radial bearings are used in a radial bearing arrangement, the clearance between the center lines along the axis of rotation of the mounted shaft results in a bearing clearance which, however, may not be sufficient for a desired stability. Therefore, the bearing clearance, i.e., the clearance between the center lines, according to the solution provided in the prior art, must be increased by arranging the bearing surfaces or the radial bearings, respectively, further apart in the axial direction, which leads to an increase in installation space and is not always possible in terms of design.

### BRIEF SUMMARY

The present disclosure overcomes the above-mentioned disadvantages and provides an aerodynamic bearing which is simple to manufacture and enables increasing the stability of a bearing arrangement in a simple manner.

According to the disclosure, an aerodynamic bearing for axial and/or radial mounting of a shaft for a turbocompressor extending along an axis of rotation is thus proposed, wherein in particular the turbocompressor is a high-speed turbocompressor and the aerodynamic bearing is preferably formed for radial mounting, i.e., as a radial bearing. The term turbocompressor is used to refer to axial, radial, and diagonal compressors collectively, so that presently, the turbocompressor can also be an axial compressor, a radial compressor, or a diagonal compressor. The aerodynamic bearing has a first bearing part denotable as a rotor, and a second bearing part denotable as a stator with respect to which the first bearing part is rotatable about the axis of rotation. The first bearing part and/or the second bearing part have a bearing surface facing the respective other bearing part and formed as described in the following, on which a gas or air cushion, respectively, for aerodynamic mounting is generatable between the bearing parts. The bearing surface has, or optionally the bearing surfaces have, respectively, a plurality of depressions, each following a predetermined longitudinal profile on or along, respectively, the bearing surface and arranged to form a predetermined pattern. In this regard, the longitudinal profile has two sections which merge into one another at an apex, preferably forming an acute angle. In this regard, it is provided according to the disclosure that the apex is located on an apex line which is displaced in parallel with respect to a center line of the bearing surface, so that the apex line is parallel to the center line and spaced apart therefrom. Thereby, the longitudinal profile is asymmetrical with respect to the center line.

Since the apex or apexes, respectively, of the depressions determine(s) the main bearing point or the main support region, respectively, of the respective bearing surface or of the bearing, respectively, it is thus displaced from the center line to the apex line, so that the pressure cushion generatable on the bearing surface is also formed to be asymmetrical and supports the bearing outside the center line.

Correspondingly, the pressure cushion can be formed in such a way that a force acting on the bearing outside the center line is supported in an optimized manner without the bearing or the bearing surface, respectively, having to be arranged in a displaced manner.

Preferably, the sections are each rectilinear upon projection onto a flat surface and/or upon creating a flat pattern of the shaft, wherein the longitudinal profile is preferably formed in an arrow shape.

Furthermore, the sections may each have a predetermined angle with respect to the apex line, wherein a first angle of a first section equals a second angle of a second section, or the angle of the first section does not equal the angle of the second section.

Due to their predetermined longitudinal profiles, the depressions may each also be referred to, for example, as a channels or grooves or radial slots which preferably extend in the radial direction into the shaft.

The depressions may also be arranged in a herringbone pattern, so that they overlap in the circumferential direction. In particular, a tip formed by a depression may engage an area spanned by an immediately adjacent depression.

In this regard, the respective width of the depressions, which is preferably measured orthogonally to the respective longitudinal profile or parallel to the center line or apex line, respectively, need not necessarily be constant. Rather, the depressions may each have, over their respective longitudinal profiles on the bearing surface in each of the sections, a uniform or varying width, which in turn may have positive effects in the optimization of the pressure cushion, in particular for high rotational speeds.

Even if the widths in each section are constant or uniform, respectively, the width in the first section and the width in the second section may be different.

Preferably, the aerodynamic bearing is formed as a radial bearing for radial mounting of a shaft for a turbocompressor extending along an axis of rotation, wherein the first bearing part is in particular formed integrally with the shaft.

A further aspect of the disclosure relates to a bearing arrangement having two aerodynamic bearings according to the disclosure formed as radial bearings. The first bearing part of the first radial bearing and the first bearing part of the second radial bearing are spaced apart from one another on the shaft or along the axis of rotation, respectively, so that a distance denotable as a real bearing clearance is located between the center lines of the two bearing surfaces along the axis of rotation. In this regard, the apex lines of the respective bearings are each arranged on the side of the respective center line facing away from the respective other bearing part, so that a distance denotable as a virtual bearing clearance, which is greater than the real bearing clearance, is located between the apex lines of the two bearing surfaces along the axis of rotation.

Thereby, the clearance or the distance, respectively, between the main support regions of the two bearings determined by the apex lines may be increased without any displacement of the bearings, and the support by the two radial bearings may be improved.

Preferably, the two radial bearings or at least the bearing surfaces of the two first bearing parts are mirror-symmetrical or point-symmetrical, respectively, with respect to a plane of symmetry located centrally between the radial bearings and orthogonal to the axis of rotation.

The features disclosed above can be combined as required, provided this is technically possible and they do not contradict one another.

### BRIEF DESCRIPTION OF THE DRAWINGS

Other advantageous developments of the disclosure are characterized in the subclaims and/or depicted in greater detail below together with the description of the preferred embodiment of the disclosure with reference to the figure. In the drawings:

FIG. 1 shows a bearing arrangement comprising two aerodynamic bearings.

### DETAILED DESCRIPTION

The figure is schematic by way of example and depicts two aerodynamic bearings 1 which form a bearing arrangement 4 of a shaft 2. The two aerodynamic bearings 1 are formed for radial mounting of the shaft 2 extending along the axis of rotation A and are thus each denotable as a radial bearing 1, wherein the depicted bearing arrangement 4 is provided in particular for usage in a high-speed turbocompressor.

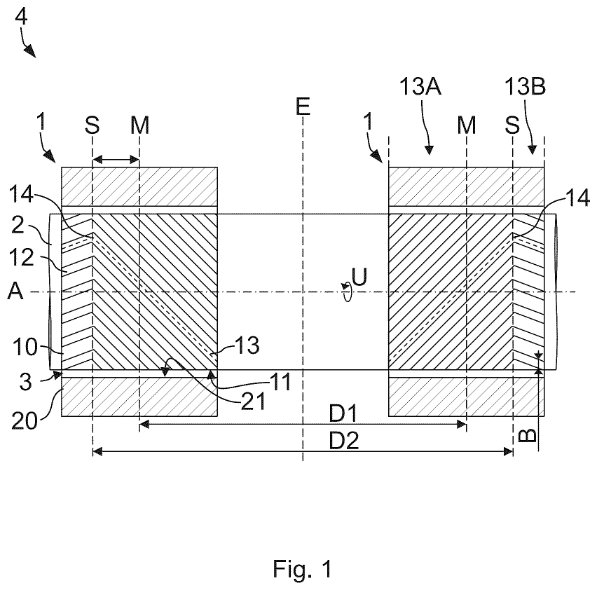

Correspondingly, each of the radial bearings 1 has two bearing partners or two bearing parts 10, 20, respectively. The first bearing part 10 is each formed as a rotor integral with the shaft 2 and is correspondingly rotatable about the axis of rotation A. The second bearing part 20 is each formed as a stator and surrounds the respective first bearing part 10 completely as well as annularly in the circumferential direction U, so that the second bearing parts 20 depicted in section in FIG. 1 essentially correspond to a hollow cylinder, wherein they could also be immediately connected to one another via an intermediate piece or formed with one another.

The bearing parts 10, 20 of a respective bearing 1 have one bearing surface 11, 21 each which face one another, so that, upon rotation of the first bearing part 10 between the bearing surfaces 11, 21, an air or gas cushion 3, respectively, is formed which serves as a lubricant or slip agent, respectively, for mounting.

In order to achieve an optimized pressure distribution of the lubricating medium, i.e., of the gas or of the air, respectively, at the bearing surface 11 of the first bearing part 10 or at the rotor bearing surface 11 of the rotor 10, respectively, even at high rotational speeds, a plurality of depressions 12 are provided on the first bearing surface 11, each of which extends in an arrow shape along a longitudinal profile 13. Correspondingly, the respective identical longitudinal profiles 13 of the depressions 12 each have two rectilinear sections 13A, 13B which are connected to one another by a bend or an apex 14, respectively.

As can be clearly seen in FIG. 1, the arrow-shaped depressions 12 overlap in the circumferential direction U, thus resulting in a pattern similar to a herringbone pattern.

Although the depressions 12 are presently depicted with a uniform width B, with the exception of the peripheral or bent regions, respectively, the width B may also vary over the longitudinal profile 13 of a respective depression 12.

In this regard, according to the disclosure, it is provided in each case that the bend or apex 14, respectively, is located precisely not on a center line M running along the bearing surface 11 centrally and orthogonally to the axis of rotation A, but on an apex line S displaced in parallel thereto, so that the depressions 12 or the pattern formed by them, respectively, is thus asymmetrical with respect to the center line M.

Thereby, the main support region formed by the pressure cushion and correspondingly influenced by the depressions 12 for supporting radial loads or radial mounting, respectively, is no longer located on the center line M, but off-center on the apex line S, which is advantageous in particular in the depicted bearing arrangement 4, since the two radial bearings 1 are mirrored with respect to a plane of symmetry E, resulting in a virtual bearing clearance D2 which is greater than the real bearing clearance D1. This leads to higher stability and smoothness of the shaft 2 mounted by the bearings 1, which is advantageous in particular for high rotational speeds.

The disclosure is not limited in its execution to the above-mentioned preferred exemplary embodiments. Rather, a number of variants are conceivable which make use of the illustrated solution even in the form of fundamentally different embodiments.

1. An aerodynamic bearing for axial and/or radial mounting of a shaft for a turbocompressor extending along an axis of rotation, the aerodynamic bearing comprising:
a first bearing part denotable as a rotor, and
a second bearing part denotable as a stator with respect to which the first bearing part is rotatable about the axis of rotation,
wherein the first bearing part and/or the second bearing part have a bearing surface facing the respective other bearing part and on which a gas cushion for aerodynamic mounting is generatable between the bearing parts,
wherein the bearing surface has a plurality of depressions, each following a predetermined longitudinal profile on the bearing surface and arranged to form a predetermined pattern,
wherein the longitudinal profile has two sections which merge into one another at an apex,
wherein the apex is located on an apex line which is displaced in parallel with respect to a center line of the bearing surface, so that the longitudinal profile is asymmetrical with respect to the center line,
wherein the two sections each have a predetermined angle with respect to the apex line,
and wherein a first angle of a first section equals a second angle of a second section, or
wherein the angle of the first section does not equal the angle of the second section.

2. The aerodynamic bearing according to claim 1,
wherein the two sections are each rectilinear upon projection onto a flat surface and/or upon creating a flat pattern of the shaft, and the longitudinal profile is formed in an arrow shape.

3. The aerodynamic bearing according to claim 1,
wherein the depressions are arranged in a herringbone pattern and overlap in the circumferential direction.

4. The aerodynamic bearing according to claim 1,
wherein the depressions each have, over their respective longitudinal profiles on the bearing surface in each of the sections, a uniform or varying width.

5. The aerodynamic bearing according to claim 4,
wherein the width in the first section and the width in the second section are different.

6. The aerodynamic bearing according to claim 1,
wherein the aerodynamic bearing is formed as a radial bearing for radial mounting of a shaft for a turbocompressor extending along an axis of rotation, and the first bearing part is in particular formed integrally with the shaft.

7. A bearing arrangement having two aerodynamic bearings configured according to claim 6 and formed as radial bearings,
wherein the first bearing parts of the two radial bearings are spaced apart from one another on the shaft, and a distance denotable as a real bearing clearance is located between the center lines of the two bearing surfaces along the axis of rotation, and
wherein the apex lines are each arranged on the side of the respective center line facing away from the respective other first bearing part, so that a distance denotable as a virtual bearing clearance, which is greater than the real bearing clearance, is located between the apex lines of the two bearing surfaces along the axis of rotation.

8. The bearing arrangement according to claim 7,
wherein the radial bearings or at least the bearing surfaces of the two first bearing parts are mirror-symmetrical with respect to a plane of symmetry located centrally between the radial bearings and orthogonal to the axis of rotation.
